(19) United States
(12) Patent Application Publication
(10) Pub. No.: US 2014/0068524 A1
(43) Pub. Date: Mar. 6, 2014

(54) INPUT CONTROL DEVICE, INPUT CONTROL METHOD AND INPUT CONTROL PROGRAM IN A TOUCH SENSING DISPLAY

(71) Applicant: FUJIFILM Corporation, Tokyo (JP)

(72) Inventor: Futoshi SAKURAGI, Tokyo (JP)

(73) Assignee: FUJIFILM Corporation, Tokyo (JP)

(21) Appl. No.: 14/012,516

(22) Filed: Aug. 28, 2013

(30) Foreign Application Priority Data
Aug. 28, 2012 (JP) 2012-187135

(51) Int. Cl. G06F 3/0481; G06F 3/0488

(52) U.S. Cl. CPC G06F 3/04812; G06F 3/0488
USPC 715/856

(57) ABSTRACT

A detection unit detects a touch input to a touch sensing display and a drag operation to a touch position. An input designation processing unit displays a cursor at the position of the touch position in the case that the touch input is detected, and keeps the cursor displayed at the touch position until the drag position deviates from a specific region to which the touch position is a reference, in the case that the drag operation of the cursor is detected. The input designation further initiates movement the cursor when the drag position deviates from the specific region and after the movement, performs a process of moving the cursor, while maintaining the relative positions between the cursor and the drag position.

### FIELD OF THE INVENTION

The present invention relates to an input control device and an input control method for performing a drag operation as well as a program which causes a computer to carry out the input control method in a touch sensing display such as a tablet PC.

### DESCRIPTION OF THE RELATED ART

Portable tablet PC's having a tabular outer shape and provided with a touch detection display have been becoming popular. In a tablet PC, direct input by using a finger or a pen, instead of indirect input through a mouse and a keyboard, is carried out on the touch sensing display. Various kinds of technologies for facilitating input to the touch sensing display have been proposed.

For example, Patent Document 1 (Japanese Unexamined Patent Publication No. 2011-186550) proposes a technique for setting a region within a predetermined range of a position, at which pen-touch has been performed, as an invalid region of operation by a finger and setting a region outside of the predetermined range as a valid region of operation by a finger, to perform simultaneous input by a pen and a finger. Further, Patent Document 2 (Japanese Unexamined Patent Publication No. 8(1996)-137609) proposes a technique for performing pen-down on a display screen to switch an input mode into various kinds of modes such as a range specification mode, a cursor movement mode and the like according to the amounts of movement of a drag operation and elapsed time after pen-down is performed. Patent Document 3 (U.S. Patent Application Publication No. 20060132460) proposes a technique for moving a cursor while maintaining the correlative relationship between a touch position and a cursor by performing a drag operation within a predetermined region, while displaying a cursor on a screen all the time. Further, Patent Document 4 (Japanese Unexamined Patent Publication No. 2011-154455) proposes a technique for determining that an input is a flick action when a finger is released after moving the finger from a touch position within a predetermined range and determining that an input is a drag action when a finger is moved beyond the predetermined range. Patent Document 5 (U.S. Patent Application Publication No. 20070291007) proposes a technique for switching between absolute mapping which generates events such as displaying a cursor by a touch operation, etc. and relative mapping which generates events while maintaining the relative positions between objects such as cursors and a finger or a pen, by a tapping operation.

### SUMMARY OF THE INVENTION

In medical care workstations, it is often the case that medical images are displayed, and precise position specification operations, such as measuring distance, specifying unnecessary regions or editing three-dimensionally displayed objects, are carried out on the displayed medical images. In particular, a position specification operation is conducted by displaying and dragging a cursor. Users, i.e., doctors, can perform various kinds of operations on medical images in desired places such as patients' rooms and operating rooms by displaying such medical images in tablet PC's. However, in tablet PC's, properly indicating specific locations is difficult because one's own finger itself becomes an obstacle when directly inputting by a finger.

In this case, a cursor can be moved without being distracted by fingers through applying the techniques disclosed in Patent Documents 2 and 5 above. However, in the technique disclosed in Patent Document 2, a cursor needs to be displayed on a screen all the time. Further, the characteristics of tablet PC's, that direct input can be performed by fingers, cannot be taken advantage of, because an input operation is performed by using a cursor. Moreover, in the technique disclosed in Patent Document 5, since three independent operations such as displaying a cursor, switching into relative mapping, and dragging are required, a drag operation of a cursor is extremely bothersome.

In view of the above-described circumstances, the object of the present invention is to facilitate the operation for dragging a cursor on a touch sensing display.

An input control device of the touch sensing display according to the present invention comprises:

detection means for detecting a touch input to a touch sensing display and a drag operation to a touch position; and

input designation processing means for displaying a cursor at a position of the touch position in the case that the touch input to the touch sensing display is detected, keeping the cursor displayed at the touch position until a drag position deviates from a specific region to which the touch position is a reference in the case that the drag operation of the cursor is detected, and initiating movement of the cursor when the drag position deviates from the specific region and after the movement, performing a process of moving the cursor, while maintaining the relative positions between a position of the cursor and the drag position.

The expression “deviates from a specific region” includes both a state where the drag position coincides with an edge portion of the specific region and a state where the drag position moves away from the edge of the specific region.

It should be noted that in the input control device according to the present invention, the input designation processing means may be a means for generating a tap event when a touch is released after a touch input is detected, in the case that no drag operation is performed or in the case that the drag position is located within the specific region.

Further, in the input control device according to the present invention, the input designation processing means may be a means for generating a flick event in the case that a drag operation at a specific speed or greater is detected, and a touch is released within a specific region after the detection of the drag operation.

Moreover, in the input control device according to the present invention, the specific region may be a region within a specific distance from a touch position.

Moreover, the input control device according to the present invention may further include region setting means for setting a specific region.

In the input control device according to the present invention, the region setting means may be a means which is capable of setting a specific region for each of a plurality of users.

An input control method for a touch-sensing detection display according to the present invention comprises the steps of:

detecting a touch input to a touch sensing display and a drag operation to a touch position;

displaying a cursor at the touch position in the case that a touch input to the touch sensing display is detected;

keeping the cursor displayed at the touch position until a drag position deviates from a specific region to which the touch position is a reference in the case that the drag operation of the cursor is detected;

initiating movement of the cursor when the drag position deviates from the specific region; and

performing a process of moving the cursor, while maintaining the relative positions between the cursor and the drag position.

It should be noted that the input control method for the touch sensing display may be provided as a program which causes a computer to carry out the method.

According to the present invention, in the case that a drag operation on a touch position is detected, a cursor is kept displayed at the touch position until the drag position deviates from a specific region to which the touch position is a reference. Further, in the case that the drag position deviates from the specific region, the cursor starts to be moved, and after starting the movement, the cursor is caused to be moved while maintaining the relative positions between the cursor and the position of the drag position. This enables users to display a cursor by touching the touch sensing display and to perform movement of the cursor by a drag operation within a single series of actions, which leads to performance of a drag operation by using a cursor without cumbersome operations. Moreover, this will reduce the difficulty of viewing the cursor due to the existence of fingers during the drag operation.

### BRIEF DESCRIPTION OF THE DRAWINGS

FIG. 1 is a perspective view of the outer appearance of a tablet PC diagram including an input control device of a touch sensing display according to an embodiment of the present invention;

FIG. 2 is a schematic block diagram illustrating the configuration of hardware built in to a tablet PC according to the embodiment of the present invention;

FIG. 3 is a flow chart illustrating a process carried out in the embodiment of the present invention;

FIG. 4 is a diagram illustrating a state in which a cursor is displayed;

FIG. 5 is a diagram for explaining drag operations and movements of a cursor;

FIG. 6 is a diagram for explaining drag operations and movements of a cursor; and

FIG. 7 is a diagram for explaining setting of regions by drag operations.

### DESCRIPTION OF THE PREFERRED EMBODIMENTS

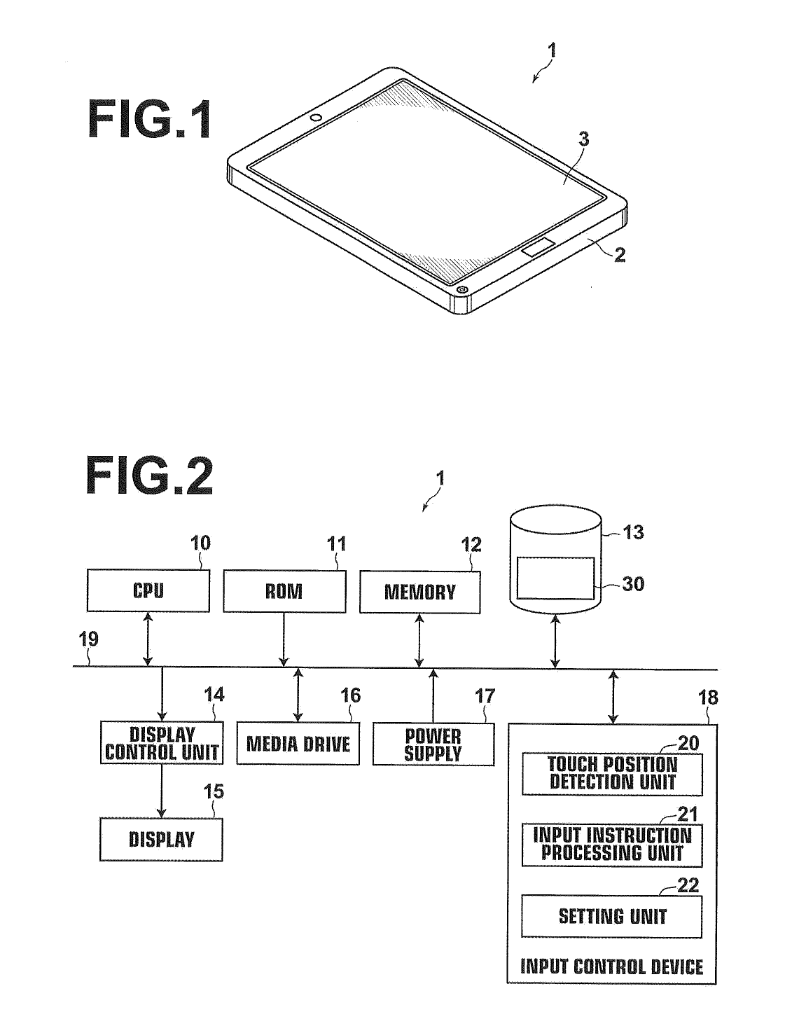

Hereinafter, an embodiment of the present invention will be described with reference to the drawings. FIG. 1 is a perspective view of the outer appearance of a tablet PC including an input control device of a touch sensing display according to an embodiment of the present invention. As shown in FIG. 1, a tablet PC 1 includes a tabular housing 2 provided with a touch sensing display 3. The touch sensing display 3 is designed to enable touch input by hands, fingers or pens.

FIG. 2 is a schematic block diagram illustrating the configuration of hardware built in to a tablet PC according to the embodiment of the present invention. As shown in FIG. 2, the tablet PC 1 includes a CPU 10, a ROM 11, a memory 12, a hard disk (HDD) 13, a display control unit 14, a display 15, a media drive 16, a power supply 17, and an input control device 18. Note that each unit is connected to one another via a bus 19.

The CPU 10 controls the entirety of the tablet PC 1 through an operating system (OS) stored in the HDD 13 and performs various kinds of processes based on various kinds of application programs stored in the HDD 13.

The ROM 11 stores BIOS and various kinds of data.

The memory 12 is constituted by a cache memory and a RAM, which is a work area when the CPU 10 carries out the various kinds of programs.

The HDD 13, stores various kinds of drivers and application programs, for example, the OS. It should be noted that the HDD 13 stores an application 30 for performing a display process of a display screen of the display 15.

The display control unit 14 performs various kinds of display in the display 15 according to the control of CUP 10.

The display 15 is a flat display such as a liquid crystal display, an organic EL display and the like, for example, and displays various kinds of information according to the control of the CPU 10 and the display control unit 14.

The media drive 16 reads and writes data on media such as CD-ROM's, DVD's and the like.

The power circuit 17 includes an AC adaptor and a rechargeable battery and supplies electrical power to each device according to control by the CPU 10.

The input control device 18 is provided on the display screen of the display 15. The input control device 18 enables users to touch a touch screen with indicators such as fingers, hands, and pens to perform display/dragging/pointing of a cursor, and input information such as commands. The input control device 18 detects coordinate locations touched by the indicator, and then outputs commands according to operations performed thereafter to the CPU 10.

The input control device 18 includes a touch position detection unit 20 which detects a touch input to the display 15 by fingers, an input designation processing unit 21 which outputs commands for performing processes according to operations after the touch input is carried out to the application 30 which is stored in the HDD 13 so as to carry out processes according to the input, and a setting unit 22 which sets specific regions required for a drag operation to be described later. It should be noted that the setting unit 22 corresponds to the region setting means.

The touch position detection unit 20 is a detection device of the capacitive sensing type. The touch position detection unit 20 includes transparent linear electric conductors arranged in X and Y directions, detects coordinate locations touched by indicators such as fingers and pens on the display 15, and outputs detected signals to the input designation processing unit 21.

The input designation processing unit 21 detects operations such as touch input and drag operations based on the detected signals which have been input from the touch position detection unit 20, and outputs commands for pointing and displaying a cursor according to the detected operations, to the CPU 10.

The setting unit 22 sets at least one of a shape and size of a specific region which is a reference for moving a cursor. It should be noted that in the present embodiment, the shape of the specific region is set as a circle of which a touch position is the center and the size of the specific region is set as a specific distance Th1, which is the radius of the circle. A value of 5 mm, for example, may be set as the specific distance Th1.

The application 30 displays lines and points that constitute parts of characters and figures on the display 15 according to the commands input from the input designation processing unit 21 and performs handwriting input of the characters and figures to display a cursor on the display 15, and executes processes such as scaling of the characters/figures displayed in the display 15, scrolling of the screen and moving of the cursor.

It should be noted that each function of the input control device 18 may be realized by causing a computer to carry out the program.

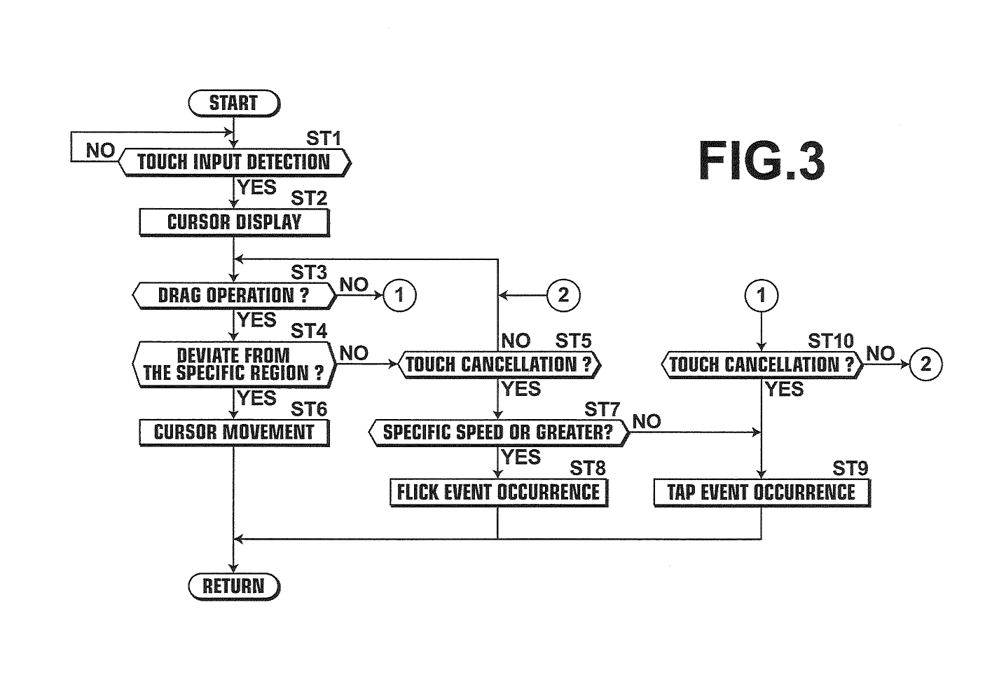

Next, the process carried out by this embodiment will be described. FIG. 3 is a flow chart illustrating a process carried out in the embodiment of the present invention. It should be noted that the characteristic feature of the present invention is displaying a cursor by touch input and moving the cursor by a drag operation. Therefore, the display and movement of a cursor will be described here.

In the case that a touch input to the display 15 is detected (step ST1 affirmation), the input designation processing unit 21 outputs a command for displaying a cursor at the touch position on the display 15, to the application 30. This causes the cursor to be displayed at the touch position (step ST2). FIG. 4 is a diagram illustrating a state in which a cursor is displayed. As shown in FIG. 4, a cursor 32 having a shape of an arrow is displayed at the touch position on the display 15. At this time, it is difficult to view the displayed cursor 32 because a finger is touching the display 15. The cursor 32 is displayed in such a manner that the point of the arrow matches the touch position.

Then, the input designation processing unit 21 determines whether a drag operation has been performed based on the detected signal from the touch position detection unit 20 (step ST3). If the result of step ST3 is affirmative, a determination is made as to whether a drag position deviates from the specific region to which a touch position is a reference (step ST4). In this embodiment, since the specific region is a circle, the process of step ST4 is carried out by determining whether the drag position moves away from the touch position by specific distance Th1 which is radius of the circle. If a negative determination is made in step ST4, the input designation processing unit 21 determines whether the touch on the display 15 is released (step ST5). If a negative determination is made in step ST5, the process returns to step ST3.

In contrast, if an affirmative determination is made in Step ST4, the input designation processing unit 21 outputs a command for moving the cursor 32 to the application 30. This causes the cursor 32 to be moved while maintaining the relative positions between the position of the cursor and the drag position (step ST6), resulting in the drag operation being performed using the cursor 32. Specifically, the cursor 32 is caused to be moved while maintaining the specific distance Th1 between the point of the cursor 32 and the drag position.

It should be noted that the specific distance Th1 is set by the setting unit 22 so as to be a value that a user desires. More specifically, when a user performs input mainly by using fingers, the specific distance is set according to thickness of the user's finger. When the user mainly performs pen input, the distance is set to be a relatively small value corresponding to the size of the point of the pen.

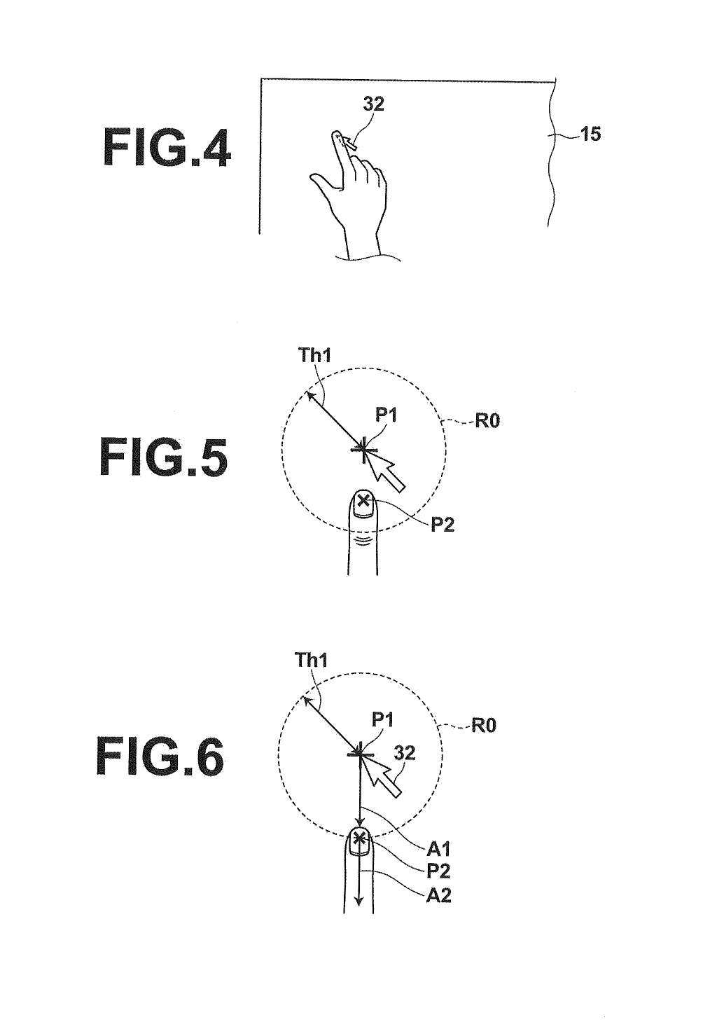

FIGS. 5 and 6 are diagrams for explaining the drag operation and movements of a cursor. As shown in FIG. 5, in the case that a drag position P2 is within a specific region R0, of which the center is a position P1 (i.e., touch position) where the cursor 32 is displayed and the radius is the specific distance Th1, the cursor is not caused to be moved. In the case that the drag operation is continued in this state and the drag position P2 deviates from the specific region R0 to which the touch position P1 is a reference, more specifically, the drag position P2 reaches the edge portion of the specific region R0, the cursor 32 is moved to the direction of an arrow A1 which is the same as the direction of an arrow A2 in accordance with the drag operation in the direction of the arrow A2 by a finger, while maintaining the specific distance Th1 between the drag position P2 and the cursor 32, as shown in FIG. 6. In this case, if the drag position P2 moves away from the edge portion of the specific region R0 by a specific distance (e.g., several pixels), the drag position P2 may be determined to deviate from the specific region R0.

Returning to FIG. 3, if an affirmative determination is made in step ST5, the input designation processing unit 21 determines whether drag speed is a specific speed or greater based on the detected signals (step ST7). If an affirmative determination is made in step ST7, the input designation processing unit 21 outputs a command for generating a flick event (operations such as switching screens and flipping pages on the display) to the application 30 on the assumption that the user has performed a flick operation (an operation such as flicking a finger at a touch position). This causes the application 30 to generate a flick event at the touch position (step ST8). If a negative determination is made in step ST7, the input designation processing unit 21 outputs a command for generating a tap event (an operation which corresponds to a double click of a mouse) to the application 30. This causes the application 30 to generate a tap event at the touch position (step ST9).

In contrast, if a negative determination is made in step ST3, the input designation processing unit 21 determines whether the touch on the display 15 is released (step ST10). If a negative determination is made in step ST10, the process returns to step ST3. If an affirmative determination is made in step ST10, the process returns to step ST9. This causes a tap event to be generated at the touch position.

In this manner, in this embodiment, in the case that a drag operation from a touch position is detected, the cursor 32 is kept displayed at the touch position without moving the cursor 32 until the drag position deviates from the specific region R0 to which the touch position is a reference. When the drag position deviates from the specific region, the cursor 32 starts to be moved, and after the start of the movement, the cursor is caused to be moved while maintaining the relative positions between the cursor and the drag position. This enables users to display a cursor 32 by touching the display 15 and to perform movement of the cursor 32 by a drag operation within a single series of actions, which leads to execution of drag operations using a cursor 32 without cumbersome operations. Moreover, this will reduce the difficulty in viewing the cursor 32 due to the existence of fingers during the drag operation.

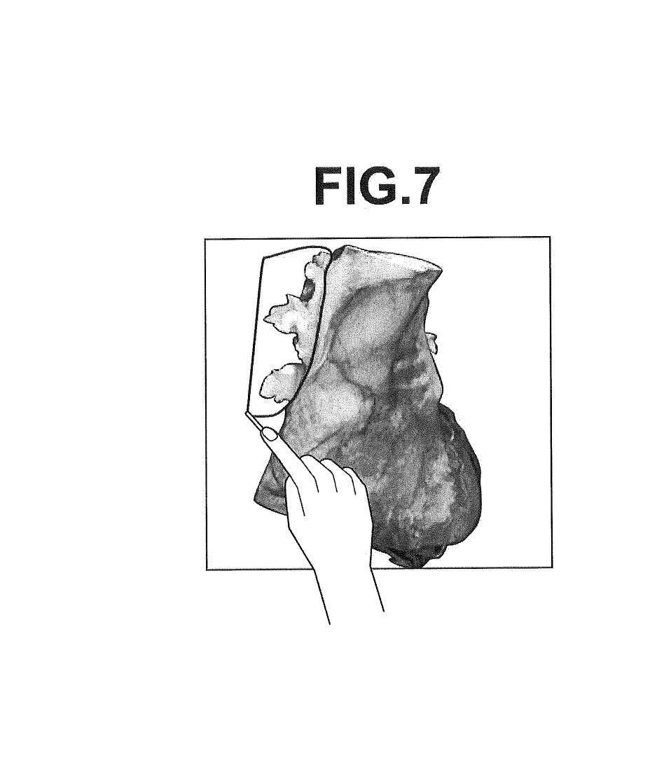

For example, when designating unnecessary regions in the medical images of a heart by a drag operation, if the cursor 32 is in a difficult condition for viewing because of a finger, the unnecessary regions cannot be designated accurately. However, according to this embodiment, there are no difficulties in viewing the cursor 32 due to the existence of the finger, and therefore the unnecessary regions can be designated accurately as shown in FIG. 7.

It should be noted that in the above-described embodiment, the setting unit 22 sets a circular specific region. Instead of the circle, regions having other desired shapes such as ovals, rectangles, and the like may be set. In this case, when the drag position is within the specific region, the cursor 32 is not moved, but when the drag position moves to the edge portion of the specific region, the cursor is caused to be moved.

Meanwhile, the size of a finger varies depending on users. Further, there are cases in which a user performs touch input mainly by using a pen. When performing touch input by a pen, even though the specific region is relatively small, the cursor 32 is generally not obstructed by a pen point. Therefore, in the case that the tablet PC 1 is shared by a plurality of users, the size of the specific region may be set according to the user. In this case, the sizes of the specific region which has been set may be associated with user IDs and stored in the HDD 13 so that the specific region to be used when performing the drag operation is changed.

What is claimed is:

1. An input control device of a touch sensing display comprising:
a detecting unit for detecting a touch input to a touch sensing display and a drag operation to a touch position; and
an input designation processing unit for displaying a cursor in a position of the touch position in the case that the touch input to the touch sensing display is detected, and for keeping the cursor displayed at the touch position until a drag position deviates from a specific region to which a touch position is a reference in the case that the drag operation of the cursor is detected, and for initiating movement of the cursor when the drag position deviates from the specific region and after the movement, performing a process of moving the cursor, while maintaining the relative positions between the cursor and the drag position.

2. The input control device as claimed in claim 1, wherein the input designation processing unit generates a tap event when the touch is released, in the case that the drag operation is not performed or in the case that the drag position is within the specific region after detection of the touch input.

3. The input control device as claimed in claim 1, wherein the input designation processing unit generates a flick event in the case that a drag operation at a specific speed or greater is detected, and after the detection the touch is released within the specific region.

4. The input control device as claimed in claim 1, wherein the specific region is a region within a specific distance from the touch position.

5. The input control device as claimed in claim 1, further comprising a region setting unit for setting the specific region.

6. The input control device as claimed in claim 5, wherein the region setting unit is capable of setting the specific region for each of a plurality of users.

7. An input control method for a touch sensing display, comprising the steps of:
detecting a touch input to the touch sensing display and a drag operation to a touch position;
displaying a cursor at the touch position in the case that the touch input to the touch sensing display is detected;
keeping the cursor displayed at the touch position until a drag position deviates from a specific region to which the touch position is a reference in the case that the drag operation of the cursor is detected;
initiating movement of the cursor when the drag position deviates from the specific region; and
performing a process of moving the cursor after the initiation of the movement, while maintaining the relative positions between the cursor and the drag position.

8. A program for causing a computer to execute an input control method for a touch sensing display, comprising the steps of:
detecting a touch input to a touch sensing display and a drag operation to a touch position;
displaying a cursor at the touch position in the case that the touch input to the touch sensing display is detected;
keeping the cursor displayed at the touch position until a drag position deviates from a specific region to which the touch position is a reference in the case that the drag operation of the cursor is detected;
initiating movement of the cursor when the drag position deviates from the specific region; and
performing a process of moving the cursor after the initiation of the movement, while maintaining the relative positions between the cursor and the drag position.
